(19) United States
(12) Patent Application Publication
(10) Pub. No.: US 2025/0292200 A1
(43) Pub. Date: Sep. 18, 2025

(54) ITEM CONDITION VERIFICATION

(71) Applicant: eBay Inc., San Jose, CA (US)

(72) Inventors: Xiaochen Wang, Mountain View, CA (US); Weixun Zhang, San Jose, CA (US); Jun Fan, San Jose, CA (US); Wei Du, Davis, CA (US); Rahul Ajaykumar Agarwal, Santa Clara, CA (US); Xiaolong Li, Shanghai (CN); Smriti Chandrasekar, Austin, TX (US); Sruthi Duvvuri, San Jose, CA (US); Simran Bhagwandasani, Campbell, CA (US)

(73) Assignee: eBay Inc., San Jose, CA (US)

(21) Appl. No.: 18/607,487

(22) Filed: Mar. 17, 2024

(51) Int. Cl. G06Q 30/0601

(52) U.S. Cl. CPC G06Q 30/0629

(57) ABSTRACT

In implementations of systems and procedures for item condition verification, a computing device implements an item condition verification system to compare a marketed condition of an item from an item listing with a delivered condition of the item using one or more machine learning models. Based on the comparison, the item condition verification system outputs a result indicating whether the item is significantly not as described by the item listing.

### BACKGROUND

Service provider systems employ digital services that are accessible via a network to support transactions involving items and services. Such service provider systems often provide listing interfaces that support browsing of various items that are made available by a variety of suppliers. Listings for such items include information describing the items, such as item condition information, digital images depicting the items, and so forth.

Some service provider systems support a return process for items purchased through item listings. Such systems will sometimes request information regarding the circumstances for an item return request in order to classify the item return request. The classification of an item return request determines the responsibilities of the item supplier and/or item recipient throughout the item return process. In some circumstances in which the item received is misrepresented by the item listing, the item supplier bears responsibility for a refund or fees associated with the return of the item.

However, if the item return request is due to recipient remorse or recipient error, the recipient is often responsible for fees associated with the return of the item. Conventional approaches for determining the accuracy of information associated with an item return request can be challenging and labor intensive. Such conventional approaches often utilize manual review of information, which can be burdensome and time intensive. Return requests for different items often have different types of information and/or different amounts of information. Further, such approaches can be subjective and prone to inaccuracies, and often result in delays to the item return process while the information is undergoing review.

### SUMMARY

Techniques for item condition verification are described. In one or more implementations, a marketed condition of an item is identified from an item listing provided by a digital service. Data describing a delivered condition of the item is also received. The data describing the delivered condition is compared to the marketed condition via a machine learning model. In some instances, the machine learning model compares digital images of the delivered condition of the item to digital images of the marketed condition of the item. In additional instances, the machine learning model compares a textual description of the delivered condition of the item to a textual description of the item from the listing. In yet further instances, the machine learning model compares images of the delivered condition to the textual description of the item from the listing, or the textual description of the delivered condition to images of the item from the listing. A result is output based on a determination of whether the item is significantly not as described by the item listing.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ an item condition verification system as described herein.

FIG. 2 depicts example content included by item delivered condition data, item marketed condition data, and listing entity data used for item condition verification operations.

FIG. 3 depicts additional components within the environment of FIG. 1.

FIG. 4 depicts a condition comparison module of the item condition verification system in an example implementation.

FIG. 5 depicts an example implementation of the item condition verification system used in an item return request procedure.

FIG. 6 depicts example content included by an item listing used by the item condition verification system for item condition verification operations.

FIG. 7 depicts operations performed by a text extraction module and a cleanup model of the item condition verification system in an example implementation.

FIG. 8 depicts operations performed by the text comparison module of the item condition verification system in an example implementation.

FIG. 9 depicts a graph portraying embeddings of a machine learning model of the text comparison module prior to fine-tuning of the machine learning model, and another graph portraying embeddings of the machine learning model after fine-tuning.

FIG. 10 depicts a graph illustrating example relative significance of various types of text content provided to the text comparison module.

FIG. 11 depicts an example implementation of a category similarity module of an image comparison module included by the item condition verification system.

FIG. 12 depicts an example implementation of an image segmentation module of the image comparison module.

FIG. 13 depicts another example implementation of the image segmentation module.

FIG. 14 depicts an example implementation of a component-to-whole-image similarity module and a feature matching module of the image comparison module.

FIG. 15 depicts an example implementation of an image alignment module and a granular comparison module of the image comparison module.

FIG. 16 depicts a flowchart illustrating a procedure for determining whether a delivered item is significantly not as described by an item listing via the item condition verification system.

FIG. 17 illustrates an example system that includes an example computing device that is representative of one or more computing systems and/or devices for implementing the various techniques described herein.

### DETAILED DESCRIPTION

### Overview

Service provider systems are implemented to support digital services such as electronic commerce platforms. Electronic commerce platforms, also known as e-commerce platforms, employ item listings to support transactions between recipients and suppliers involving goods and services. For example, a listing entity interacts with a service provider system via an interface to provide information describing an item for sale. An item listing associated with the item is generated using the item information. The listing entity refers to the entity that provides the information to be included in the item listing, such as the supplier of the item. The item listing is made available via the service provider system to potential recipients. A recipient then interacts with the item listing to purchase the item, and the listing entity arranges delivery of the item to the recipient.

In some situations, however, once a recipient has received an item purchased via an item listing as described above, the recipient is dissatisfied with the delivered item. As an example of one such situation, the recipient completes the transaction for the item but decides at a later time that the item is no longer desired. In another example situation, the recipient unintentionally completes the transaction for the item or misunderstands the description of the item in the item listing. In yet another example situation, the recipient considers that the received item is significantly different compared to images and/or text describing the item in the item listing.

In order to resolve such issues, recipients initiate item return requests to return items to suppliers. However, some suppliers do not accept returned items unless the return meets certain criteria. Thus, in this situation in which a recipient simply decides the delivered item is unwanted and the supplier has a no-return policy, a dispute between the recipient and supplier can occur.

Disputes between recipients and suppliers increase a burden on service provider systems and consequently computing devices that implement these systems. Large numbers of disputes reduce recipient and supplier confidence, and conventional approaches to resolving disputes involve manual review of transaction information. This conventional approach is time consuming and can be subject to error. In particular, the subjective nature of manual review can result in incomplete consideration of all of the transaction information available. Consequently, certain actions undertaken to resolve a dispute may be performed even if different actions would have been more appropriate based on the available transaction information. Further, manual review often relies on familiarity with the wide variety of item types associated with different item listings. Otherwise, inaccuracies can occur. The additional electronic communications associated with resolving disputes also increases a load on electronic devices that support operation of the service provider system, such as processors, memory, storage, power consumption, and so forth.

In some real-world scenarios, a dispute leading to item return request is a result of an alleged misrepresentation of an item in an item listing. For instance, a recipient receives an item purchased through an item listing. Once the recipient receives the item, the recipient alleges that the actual delivered condition of the item does not match the condition of the item described by the item listing.

When such a dispute occurs, conventional techniques employed for dispute resolution resolve the dispute in each instance in favor of the recipient or the supplier. However, this type of resolution can reduce both recipient and supplier confidence. For instance, suppliers can become frustrated by increased costs associated with return shipping of the item during situations in which the item has been accurately described by the item listing. Likewise, resolution in favor of the supplier can reduce recipient confidence. For instance, recipients can feel that they are unable to reach a satisfactory dispute outcome if the delivered items do not match the descriptions from the item listings.

Accordingly, techniques for item condition verification are described that address these technical challenges. In one or more implementations, a service provider system is configured to verify a delivered condition of an item. The delivered condition is compared to a marketed condition of the item acquired from an item listing. The delivered condition and the marketed condition can each include a respective textual description of the item and respective digital images of the item. A machine learning model trained to perform the verification determines whether the item is significantly not as described by the item listing and outputs a result of the determination. In this way, disputes between recipients and suppliers occurring due to alleged differences between the delivered condition of items and the marketed condition of the items are resolved more quickly, fairly, and without human intervention. This reduces occurrences of manual reviews of disputes and reduces a load on the service provider system.

Consider a scenario in which a recipient completes a transaction for a book using an item listing employed by an e-commerce platform. Shipping information is provided to the service provider system for delivery of the book to the recipient. Once the recipient receives the book, the recipient believes that the condition of the book does not match the condition described by the item listing. Example perceived differences in the condition can include unexpected wear or degradation of the book, an unexpected book title, an unexpected book cover, and so forth.

As a result of the perceived differences, the recipient initiates a return of the book to the supplier through the service provider system for a refund or replacement of the book. The recipient is prompted by the service provider system to provide a textual description of the delivered book. Additionally, the recipient is prompted in one or more examples by the service provider system to provide one or more digital images of the delivered book. The textual description and/or the one or more digital images are input, e.g., uploaded, to the service provider system.

The service provider system compares the input information to information acquired from the item listing, e.g., using one or more machine learning models. The one or more machine learning models determine an amount of similarity between the input digital images and digital images acquired from the item listing. The one or more machine learning models additionally determine an amount of similarity between the input textual description and textual information describing the book acquired from the item listing. In some situations, the one or more machine learning models additionally determine an amount of similarity between the input textual description and the digital images acquired from the item listing, and/or an amount of similarity between the input digital images and the textual information acquired from the item listing.

Following the comparison described above, a determination is made by the service provider system as to whether the delivered book is significantly different (e.g., more than a threshold amount) from the book as described by the item listing. In particular, the determination indicates whether the delivered book is significantly not as described by the item listing. Based on the outcome of the determination, the service provider system performs one or more operations for resolution of the dispute. Such operations include, for instance, resolving the dispute in favor of the recipient, resolving the dispute in favor of the supplier, or flagging the dispute for additional review.

In this way, the service provider system efficiently and quickly assesses the condition of delivered items for the purpose of determining whether the items are significantly not as described by the associated item listings. The outcomes of the determinations are used to guide operations performed for the resolution of disputes involving the items. As a result, disputes are resolved more quickly and with increased accuracy relative to conventional approaches, which increases recipient and supplier confidence in the e-commerce platform. Additionally, by reducing occurrences of manual review of disputes, a load of the service provider system is reduced. For instance, allocation of resources to support electronic communications for resolution of disputes is reduced.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example Environment

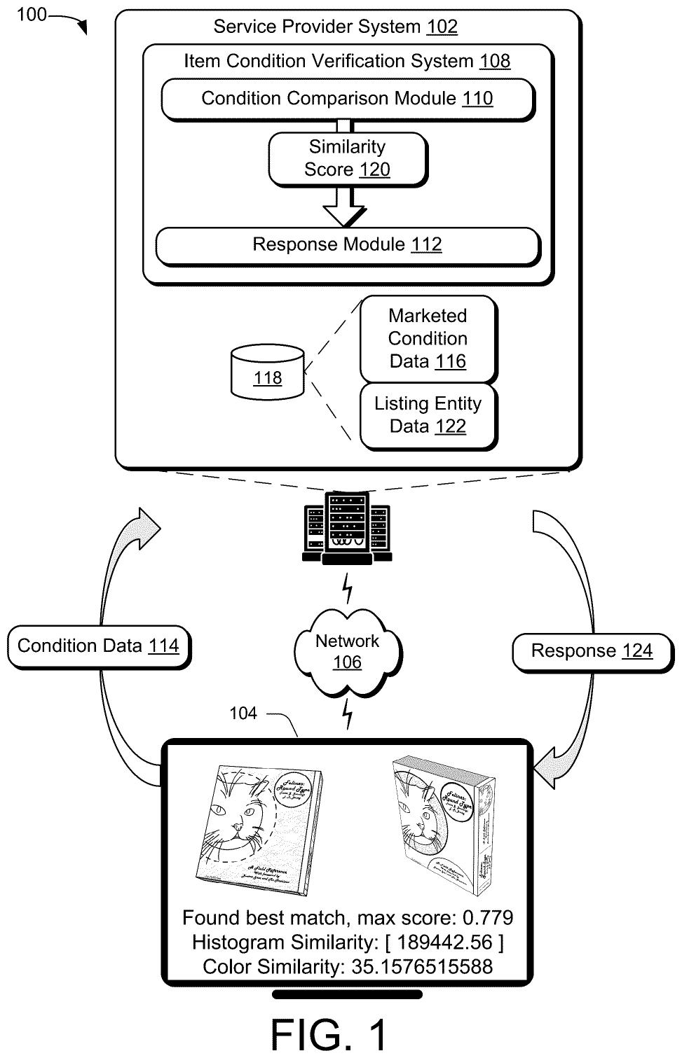

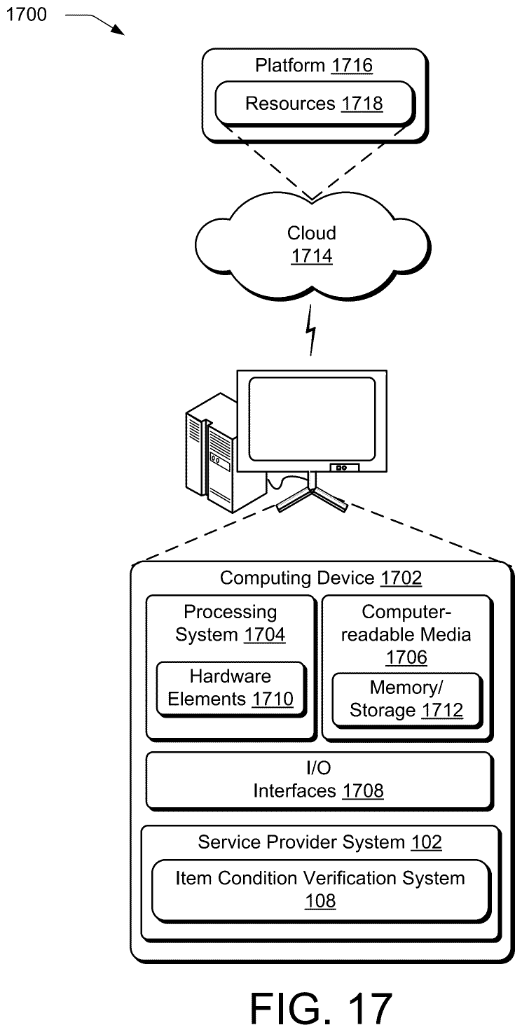

FIG. 1 is an illustration of a digital medium environment 100 in an example implementation that is operable to employ item condition verification techniques described herein. The illustrated environment 100 includes a service provider system 102 and a computing device 104 that are communicatively coupled, one to another, via a network 106. The computing device 104 and computing devices that implement the service provider system 102 are configurable in a variety of ways, examples of which are further described in relation to FIG. 17. The computing device 104 is referred to herein as a processing device, in some instances.

The service provider system 102 is a computing device, or multiple computing devices communicatively coupled to each other, and is configured to support operation of the modules and other systems described herein. In one or more examples, the service provider system 102 supports the modules and systems described herein to implement a platform such as an electronic commerce (e-commerce) website or other online marketplace accessible to end users via other electronic devices such as personal computers, smartphones, and so forth. For instance, the service provider system 102 is configurable to include electronic storage media, transitory memory and non-transitory memory, one or more electronic processors, and other components configured to facilitate operation of the online marketplace. The service provider system 102 in some instances includes multiple servers, databases, and/or other electronic devices to support storage of data such as item listings, recipient and supplier profiles, and other data associated with operation of the service provider system 102 and/or content provided by the service provider system 102 to end users at the computing device 104. In such configurations, the multiple servers and/or other electronic devices are utilized to perform operations “over the cloud” as also described in relation to FIG. 17.

The service provider system 102 implements the platform accessible to end-users over a network 106, e.g., as digital services. The network 106 in some instances is the internet, and the service provider system 102 employs the platform as a website accessible via computing devices external to the service provider system 102, such as computing device 104.

Suppliers, also referred to as listing entities, provide input to the service provider system 102 to generate item listings to be employed by the service provider system 102 on the platform. Recipients navigate the various item listings via computing devices such as computing device 104 and complete transactions for items. The purchased items are made available to the recipients for local pickup and/or delivery to the recipients via a delivery service.

The service provider system 102 is shown including item condition verification system 108. The item condition verification system 108 is employed by the service provider system 102 to perform operations, automatically and without user interaction, related to delivered item condition verification. To do so, the item condition verification system 108 includes a condition comparison module 110 and a response module 112.

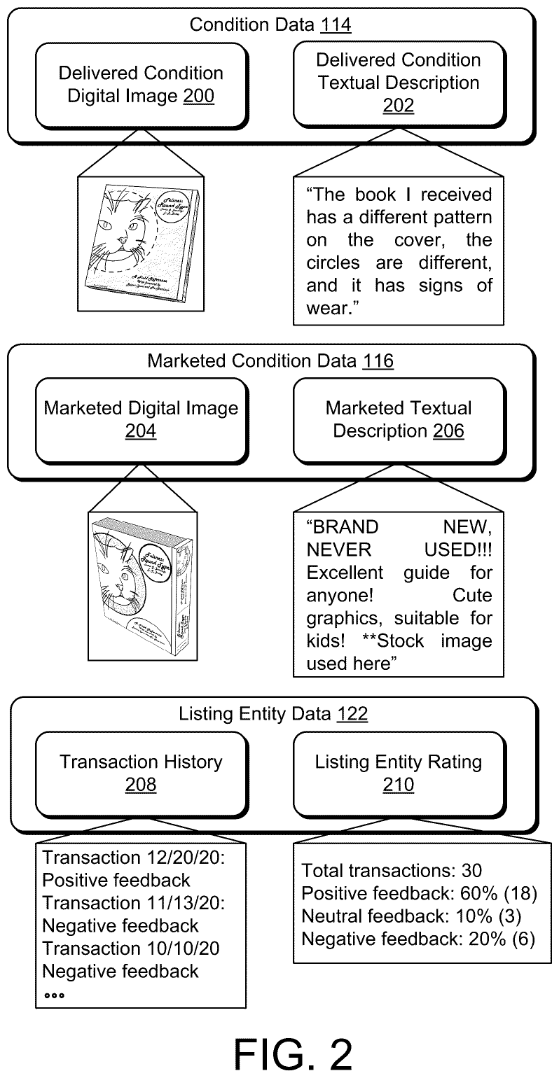

In the example shown, condition data 114 is provided by the computing device 104 to the item condition verification system 108 of the service provider system 102. The condition data 114 describes a delivered condition of an item, e.g., purchased via an item listing, and is referred to herein as delivered condition data in some instances. The condition data 114 includes, for instance, digital images of a delivered condition of an item. An example delivered condition digital image 200 is shown by FIG. 2. The condition data 114 additionally or alternatively includes a textual description of the delivered condition of the item. The textual description of the delivered condition of the item includes information such as a written description of wear of the delivered item and/or a written description of particular features of the item. An example delivered condition textual description 202 is also shown in FIG. 2.

The item condition verification system 108 further receives marketed condition data 116 describing a marketed condition of the item, e.g., from a storage device 118. The marketed condition data 116 includes, for instance, digital images of the item acquired from the item listing. An example marketed digital image 204 is shown by FIG. 2. The marketed condition data 116 additionally or alternatively includes a textual description of the item acquired from the item listing. The textual description includes information such as a supplier-provided description of wear of the item and/or supplier-provided description of an appearance of the item. An example marketed textual description 206 is shown by FIG. 2.

The condition comparison module 110 is configured to compare the received condition data 114 and the marketed condition data 116 and from this, generate a similarity score 120 based on the comparison. The similarity score 120 indicates an amount of similarity between the delivered condition of the item and the marketed condition of the item. The marketed condition of the item refers to the condition of the item as described by the item listing. In some instances, the similarity score 120 is referred to herein as an overall similarity score.

In some implementations, the condition comparison module 110 weights or otherwise adjusts the similarity score 120 based on listing entity data 122. The listing entity data 122 is stored by the service provider system 102. The listing entity data 122 is provided to the item condition verification system 108 during conditions in which the item condition verification system 108 performs item condition verification operations via the condition comparison module 110. The item listing includes information describing the item as provided by the listing entity. Additionally, the item listing includes at least a portion of listing entity data 122. The listing entity data 122 includes, for instance, a profile name and/or real name of the listing entity, a physical address of the listing entity, a rating of the listing entity, and a transaction history of the listing entity. An example of a transaction history 208 of the listing entity and a listing entity rating 210 are each shown by FIG. 2.

The similarity score 120 is provided to the response module 112 of the item condition verification system 108. The response module 112 outputs a response 124 based on the similarity score 120. A content of the response 124, for instance, is based on a content of the similarity score 120. In some instances, the similarity score 120 is formatted as a numerical value within a pre-determined range of values, e.g., a range including values from zero to one hundred. The response 124 is also referred to herein as the result of determining of the amount of similarity between the delivered condition of the item and the marketed condition of the item, in some instances.

The numerical value can be expressed as a percentage in the response 124. In an example in which the numerical value of the similarity score is equal to sixty (within the range of values from zero to one hundred), the similarity score 120 may be expressed as sixty percent within the response 124. In this example, the response 124 indicates that the amount of similarity between the condition data 114 and the marketed condition data 116 is sixty percent based on the similarity score 120.

In some implementations, the response module 112 compares the similarity score 120 to one or more pre-determined threshold similarity scores to generate the response 124. In one example, the response module 112 compares the similarity score 120 to a threshold similarity score having a numerical value equal to fifty. If the value of the similarity score 120 is less than fifty, the response module 112 outputs the response 124 with a first content. However, if the value of the similarity score 120 is equal to or greater than fifty, the response module 112 outputs the response 124 with a second content. The first content includes, for instance, an indication that the condition of the delivered item is significantly not as described by the item listing. The second content includes, for instance, an indication that the condition of the delivered item matches the condition described by the item listing. Although a threshold score of fifty is described as an example, other threshold scores are possible.

In an example implementation of the service provider system 102, a recipient purchases an item through an item listing implemented by the service provider system 102. The purchased item is delivered to the recipient. Following inspection of the item, the recipient believes that the condition of the item does not match the condition described by the item listing. The recipient initiates a return request for the item. Initiation of the return request occurs via communication between the computing device 104 and the service provider system 102. The communication includes, for instance, input provided through an interface implemented by the service provider system 102, such as an item return webpage.

Following the initiation of the return request, a description of the delivered item and one or more digital images of the delivered item are communicated to the service provider system 102 via input applied to the computing device 104. The service provider system 102 provides the information describing the delivered item to the item condition verification system 108 as condition data 114. The item condition verification system 108 additionally acquires marketed condition data 116 from the item listing and listing entity data 122 from storage of the service provider system 102.

The item condition verification system 108 compares the condition data 114 with the marketed condition data 116 to determine an amount of similarity between the condition data 114 and the marketed condition data 116. The condition comparison module 110 then outputs similarity score 120. The similarity score 120 is input to the response module 112, and the response module 112 compares the similarity score 120 to a threshold score. The similarity score 120 and/or the threshold score is weighted according to listing entity data 122. Based on an outcome of the comparison, the response module 112 adjusts a content of response 124 output by the item condition verification system 108.

Based on the content of the response 124, the service provider system 102 performs additional operations to facilitate resolution of the return request. In the example shown by FIG. 1, the response 124 indicates that item condition verification system 108 has determined that the condition of the delivered item is significantly not as described by the item listing. As a result of this determination, the service provider system 102 performs operations such as communicating to computing device 104 that the item return request is approved. The service provider system 102 additionally performs operations such as communicating to the supplier an instruction to process a refund or provide a replacement for the item.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Item Condition Verification

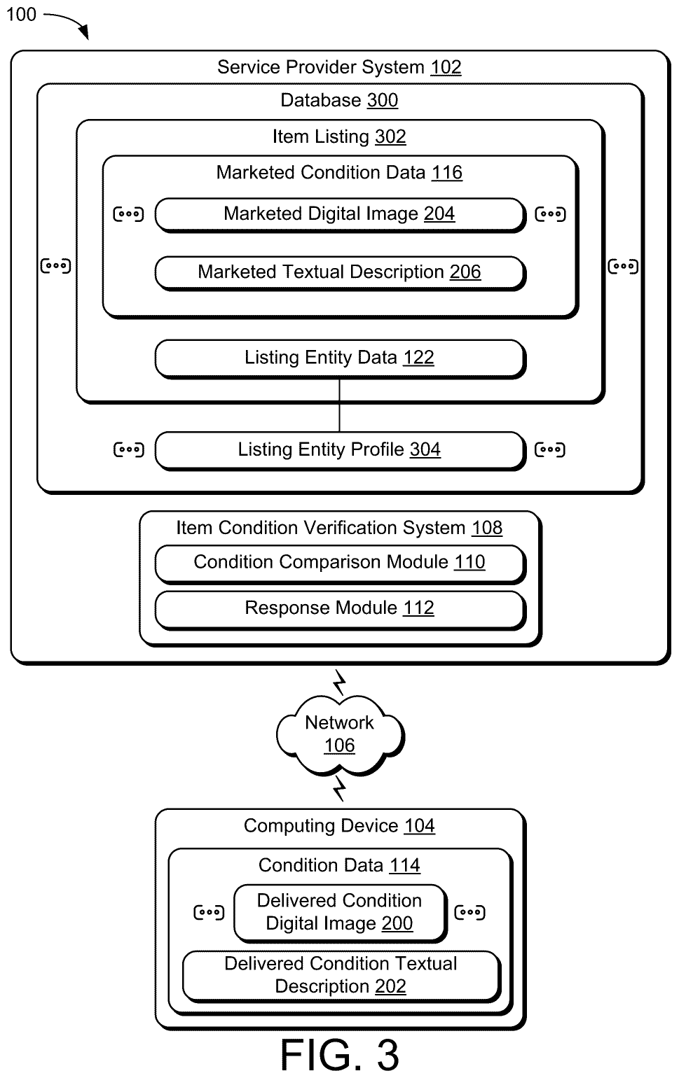

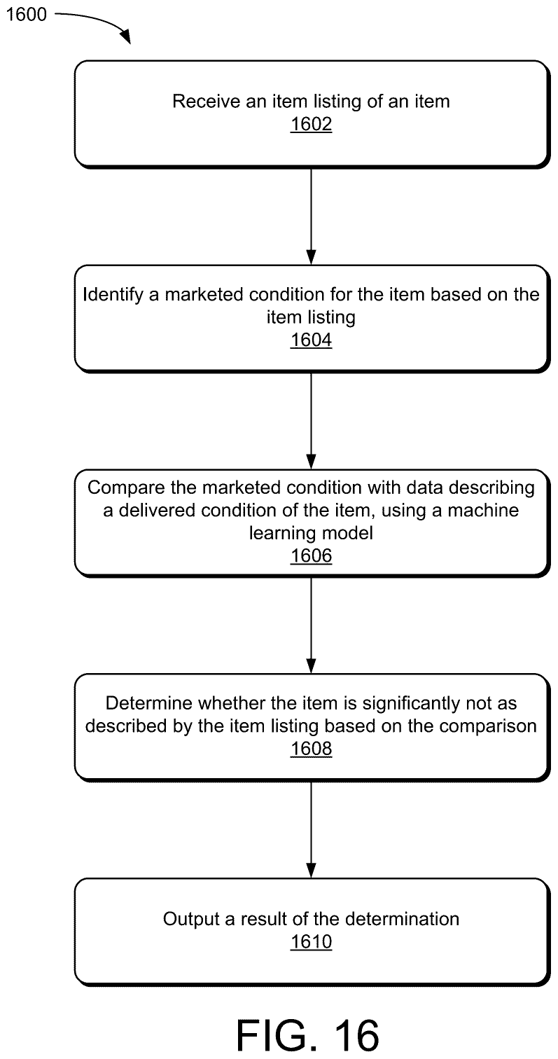

The following discussion describes item condition verification techniques that are implementable utilizing the described systems and devices. Aspects of the procedure are implemented in hardware, firmware, software, or a combination thereof. The procedures are shown as sets of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIG. 16 shows a flow diagram depicting an algorithm as a step-by-step procedure 1600 in an example implementation of operations performable for accomplishing a result of item condition verification. In portions of the following discussion, reference will be made to FIGS. 3-15 in parallel with the procedure 1600 of FIG. 16.

Referring to FIG. 3, an example of operation of the service provider system 102 is shown in greater detail. The service provider system 102 includes a plurality of databases, such as database 300, for storage of data, which may be implemented by storage device 118 of FIG. 1. Such data includes, for example, item listing 302 data and user profile data. In some implementations, the databases are external to the service provider system 102 and the service provider system 102 communicates electronically with the databases via a wired or wireless connection.

The service provider system 102 supports a plurality of item listings via the databases, such as item listing 302. The item listings are associated with items offered for sale, trade, delivery, and so forth via the service provider system 102. Item listings include various types of data describing the items, such as digital images, textual descriptions, and item prices.

The service provider system 102 additionally supports a plurality of listing entity profiles via the databases, such as listing entity profile 304. Each listing entity profile includes corresponding listing entity data 122. Examples of listing entity data 122 include a listing entity transaction history and a listing entity rating. Portions of the listing entity data 122 are additionally included by the item listing 302, in some instances.

As described above, the condition comparison module 110 utilizes the listing entity data 122 to weight outcomes of data comparisons performed by the condition comparison module 110. Weighting the outcome of a data comparison performed by the condition comparison module 110 includes, for instance, adjusting an outcome based on the listing entity transaction history and/or listing entity rating. In an implementation, the listing entity transaction history includes a record of previous outcomes of data comparisons performed by the condition comparison module 110 using data from item listings associated with the listing entity. The condition comparison module 110 references the recorded outcomes to weight subsequent outcomes for item return requests involving the listing entity.

In an example scenario, a listing entity profile includes a record of a first transaction for a first item and a second transaction for a second item. The record includes data describing an outcome of a first item return request involving the first item. The record additionally includes data describing an outcome of a second item return request involving the second item. In this example, the outcome of the first item return request is based on a determination by the condition comparison module 110 that the first item is significantly not as described by the listing for the first item. The outcome of the second item return request is based on a determination by the condition comparison module 110 that the second item was accurately described by the listing for the second item.

A transaction for a third item described by a third item listing occurs subsequent to the return requests involving the first item and the second item. The third item listing is associated with the listing entity profile. A return request for the third item occurs, and the condition comparison module 110 is employed to determine whether the third item is significantly not as described by the third item listing. The condition comparison module 110 compares data describing the delivered condition of the third item to data describing the marketed condition of the third item. The condition comparison module 110 then generates a similarity score based on the comparison.

In this scenario, the condition comparison module 110 weights the similarity score based on the record describing the outcome of the first item return request and the outcome of the second item return request. In particular, the condition comparison module 110 determines instances in which items were significantly not as described by item listings associated with the listing entity. The condition comparison module 110 then adjusts the similarity score for the third item based on this data. Adjusting the similarity score associated with the third item includes, for instance, increasing the score due to the outcome of the first item return request. However, adjusting the score also includes, in some implementations, lowering the score due to the outcome of the second item return request. Thus, outcomes in which items are determined by the condition comparison module 110 to be significantly not as described by item listings are referenced to bias subsequent outcomes.

In this way, the item condition verification system 108 accounts for suppliers that frequently misrepresent items in item listings and weights the output of the response module 112 accordingly. In some implementations, the item condition verification system 108 weights the similarity score 120 in an opposite manner if a supplier has little or no record of misrepresentation of items in item listings. Although the weighting is described as increasing or decreasing the similarity score 120, in some examples the weighting is instead performed by increasing or decreasing the threshold scores to which the similarity score 120 is compared.

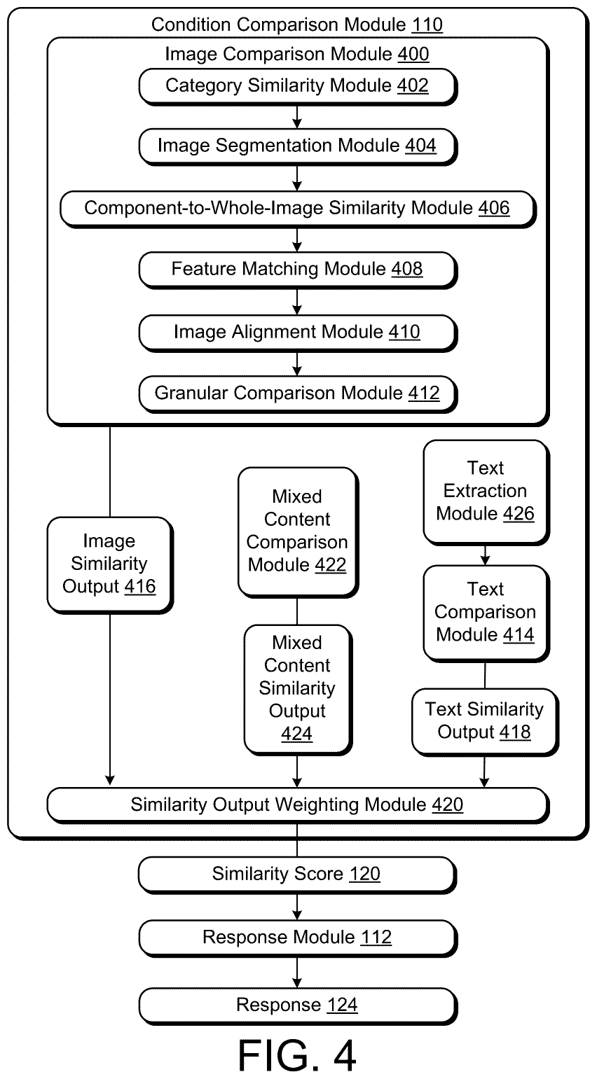

Referring to FIG. 4, the condition comparison module 110 of the item condition verification system 108 is shown in greater detail. The condition comparison module 110 includes various modules employed for comparison of image data, such as digital images, and textual data, such as written item descriptions.

The condition comparison module 110 includes image comparison module 400. The image comparison module 400 is employed to compare image data. Example image data includes digital images included by condition data 114 and marketed condition data 116. The image comparison module 400 employs one or more machine learning models to perform operations supporting comparison of image data. The one or more machine learning models are trained on data describing a plurality of item transactions and outcomes, in some implementations. Such training data includes, for instance, transactions supported by the service provider system 102 that resulted in item return requests, and the outcomes of said item return requests. The training data includes image data associated with item return requests processed via manual review, in some implementations, along with data describing the manual review outcomes. Such image data includes digital images from item listings and digital images from recipients, for instance.

The condition comparison module 110 further includes text comparison module 414. The text comparison module 414 employs one or more machine learning models to perform operations supporting comparison of textual data. The one or more machine learnings models are trained on the data describing the plurality of item transactions and outcomes in some implementations. A content of the data used for training the text comparison module 414 includes, in some implementations, textual data from item listings, and textual data from recipients and suppliers associated with item return requests.

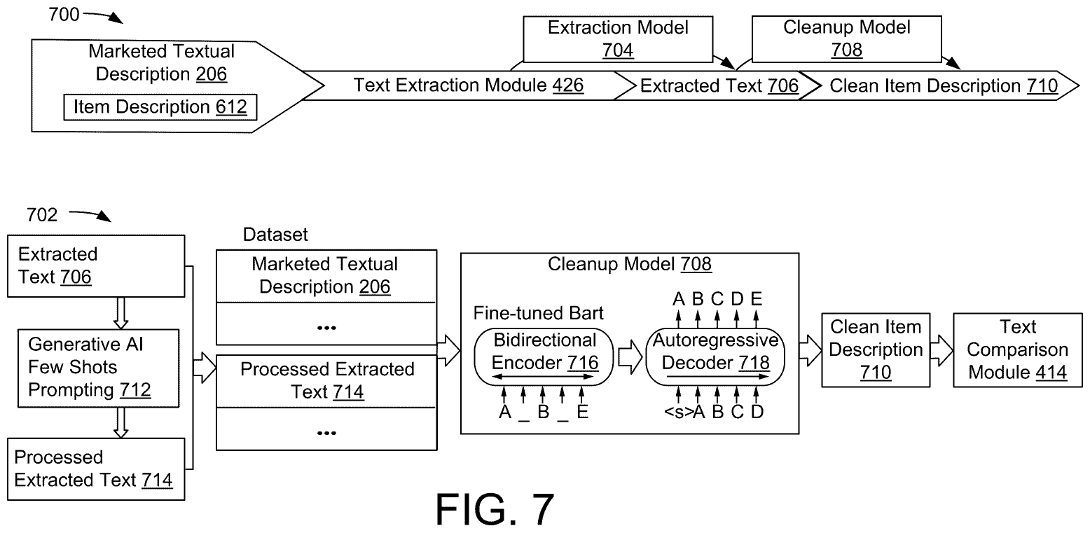

A text extraction module 426 receives textual information as input and employs one or more machine learning models to generate an output including an edited version, e.g., cleaned version, of the textual information. The text extraction module 426 for instance employs the one or more machine learning models to extract key words and phrases from the textual information input to the text extraction module 426. The edited textual data is provided as input to the text comparison module 414. The text comparison module 414 compares the input textual data and generates a text similarity output 418. Example implementations of the text extraction module 426 are described further below, e.g., with reference to FIG. 7.

The condition comparison module 110 further includes mixed content comparison module 422, in some implementations. The mixed content comparison module 422 employs one or more machine learning models to perform operations supporting comparison of textual data with image data, and vice versa. The mixed content comparison module 422 compares the mixed content including image data and textual data and generates a mixed content similarity output 424. The one or more machine learning models are trained on the data describing the plurality of item transactions and outcomes in some implementations. A content of the data used for training the mixed content comparison module 422 includes, in some implementations, textual data and image data from item listings, and textual data and image data from recipients and suppliers associated with item return requests.

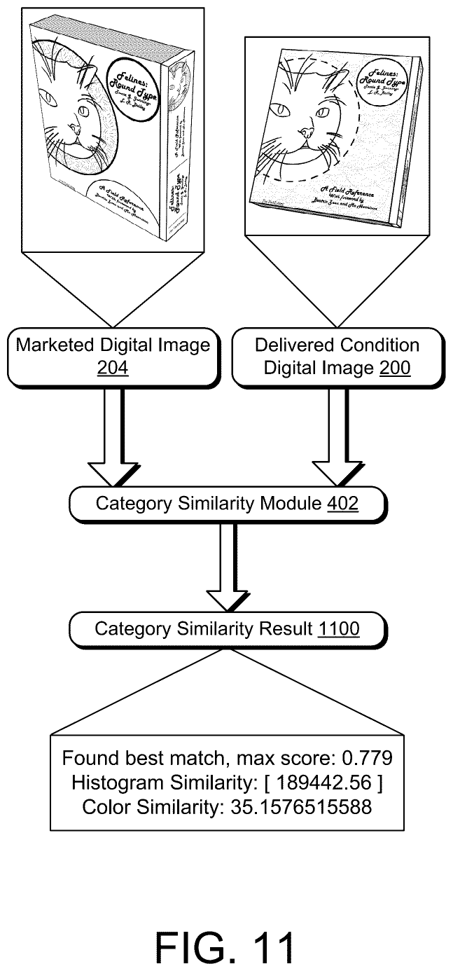

The image comparison module 400 includes a plurality of modules employed to perform various operations to facilitate image comparison. In particular, the image comparison module 400 includes category similarity module 402, image segmentation module 404, component-to-whole-image similarity module 406, feature matching module 408, image alignment module 410, and granular comparison module 412. Example implementations of the modules are described further below with reference to FIGS. 11-15.

Each module of the image comparison module 400 is configurable to communicate electronically with one or more other modules of the image comparison module 400 to perform the image comparison operations described herein. In the implementation shown by FIG. 4, the category similarity module 402 is employed to compare the image data and determine a category similarity result. Image segmentation module 404 is employed to perform segmentation of the image data. Segmentation of the image data includes identification of a plurality of segments or areas from the image data. Component-to-whole-image similarity module 406 is employed to compare the plurality of segments of the image data to whole digital images included in the image data. Feature matching module 408 is employed to determine matches between features of digital images included in the image data. Image alignment module 410 is employed to adjust an orientation and/or aspect ratio of the plurality of segments and the digital images included in the image data. Granular comparison module 412 is employed to compare a granularity of the digital images included in the image data.

The image comparison module 400 compares the input image data and generates an image similarity output 416. In some implementations, the image similarity output 416 is formed as a combination of outputs of the various modules included by the image comparison module 400. In one implementation, one or more of the modules of the image comparison module 400 outputs an intermediate similarity score, and the intermediate similarity scores are averaged or otherwise combined to form the image similarity output 416.

In the implementation shown by FIG. 4, the modules are employed sequentially. For instance, an output of the category similarity module 402 is input to the image segmentation module 404, an output of the image segmentation module 404 is input to the component-to-whole-image similarity module 406, etc. However, in other implementations, the ordering of the modules may be different.

The condition comparison module 110 further includes similarity output weighting module 420. The similarity output weighting module 420 is employed to weigh the comparisons performed by the condition comparison module 110 for generation of the similarity score 120. To do so, the similarity output weighting module 420 receives the image similarity output 416 and the text similarity output 418. The similarity output weighting module 420 applies weights to the image similarity output 416 and/or the text similarity output 418 while combining the outputs to generate the similarity score 120.

In an implementation, the image similarity output 416 is formatted as a first score and the text similarity output 418 is formatted as a second score. The similarity score 120 is a composite score formed from each of the first score and the second score. The similarity output weighting module 420 adjusts a contribution of each of the first score and the second score toward forming the similarity score 120. In one example scenario, the similarity output weighting module 420 weights the scores such that the text similarity output 418 contributes to sixty percent of the similarity score 120 and the image similarity output 416 contributes to forty percent of the similarity score 120. However, different weighting of the similarity score 120 is possible.

In another example scenario, the image similarity output 416 is input to the similarity output weighting module 420, but the text similarity output 418 is not input to the similarity output weighting module 420. As a result, the similarity score 120 is based on the image similarity output 416 and is not based on the text similarity output 418.

In additional implementations, the similarity output weighting module 420 receives mixed content similarity output 424 generated by the mixed content comparison module 422. The similarity score 120, therefore, is further formed from the mixed content similarity output 424. The contribution of the mixed content similarity output 424 toward generating the similarity score 120 is controllable by the similarity output weighting module 420.

The weighting performed by the similarity output weighting module 420 is based on an amount of each type of data available, in some implementations. For instance, during conditions in which a smaller amount of image data is compared by the image comparison module 400, a contribution of the image similarity output 416 to the similarity score 120 is lower. However, during conditions in which a larger amount of image data is compared by the image comparison module 400, a contribution of the image similarity output 416 to the similarity score 120 is higher. One example of the smaller amount of image data is four images, and one example of the larger amount of image data is eight images. Other amounts are possible.

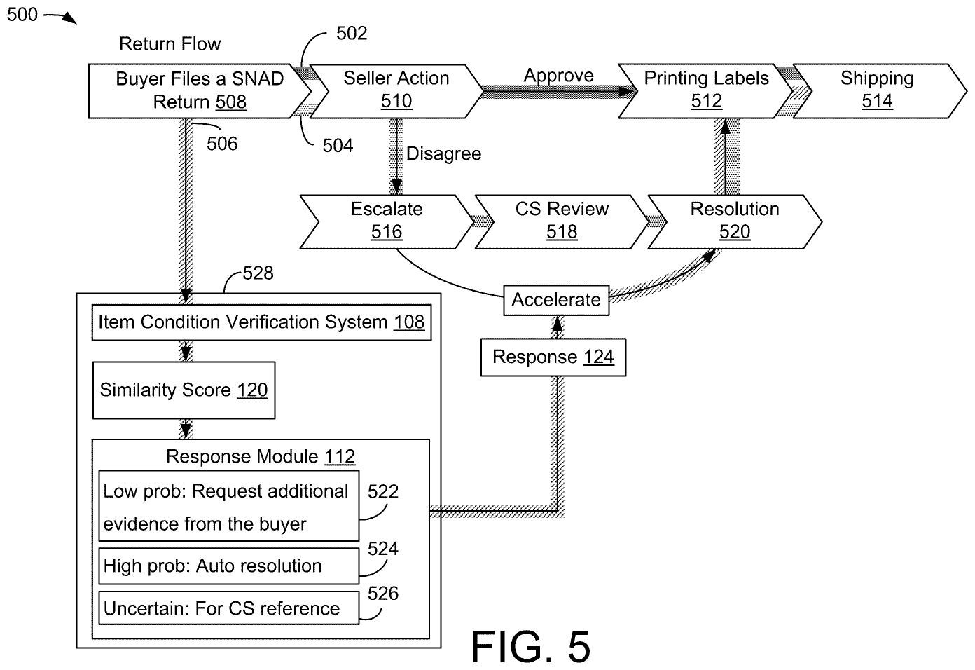

Referring to FIG. 5, an example implementation of the item condition verification system 108 in an item dispute resolution procedure is shown. In particular, block diagram 500 depicts various steps associated with an item return request.

Various routes for resolution of the item return request are shown. A first route 502 is represented by a first shading, a second route 504 is represented by a second shading, and a third route 506 is represented by a third shading. Block 508 depicts initiation of the item return request by a recipient.

The item return request proceeds along the first route from block 508 to block 510. Block 510 represents a supplier action performed responsive to the item return request. The supplier action according to the first route includes approval of the item return request. In particular, the supplier does not dispute the item return request and accepts the terms of the item return request. As a result, the item return request proceeds from block 510 to block 512. At block 512, labels are printed for the item return. The item return request proceeds from block 512 to block 514. At block 514, the item is shipped to the supplier.

In some scenarios, the item return request is not approved by the supplier. As a result, the item return request proceeds along the second route 504 from block 510 to block 516. At block 516, the item return request is escalated. Escalation of the item return request includes flagging the item return request for manual review by human personnel, e.g., customer service, of the e-commerce platform at block 518. The item return request proceeds from block 518 to block 520. At block 520, a resolution for the item return request is determined. In this example in which the item return request proceeds along the second route 504, the resolution for the item return request at block 520 is determined by the human personnel based on the manual review at block 518. The item return request then proceeds from block 520 to block 512, and the item return request proceeds from block 512 to block 514 as described above.

The above-described examples of the first route and the second route for the item return request do not utilize the item condition verification system 108. However, FIG. 5 depicts third route 506 in which the item return request proceeds from block 508 to block 528. At block 528, item condition verification system 108 is implemented to perform item condition verification, similar to the examples described above. In particular, the item condition verification system 108 receives data describing the delivered condition of the item and compares the delivered condition data to data describing the marketed condition of the item from the item listing (block 1606 shown by FIG. 16). The item condition verification system 108 outputs similarity score 120, and the similarity score 120 is received by response module 112. The response module 112 determines a content of response 124 based on the similarity score 120.

In an implementation, the content of response 124 is based on outcome 522 in which the similarity score 120 is higher than a first pre-determined threshold score. In this situation, the item condition verification system 108 determines based on the similarity score 120 that the likelihood that the delivered item is significantly not as described by the item listing is low. As a result, the service provider system 102 prompts the recipient for additional data describing the delivered condition of the item. However, in some situations, the service provider system 102 performs a different operation responsive to the determination, such as cancelling the item return request or notifying the recipient of additional shipping costs associated with the item return.

In another implementation, the content of response 124 is based on outcome 524 in which the similarity score 120 is lower than a second pre-determined threshold score. In this situation, the item condition verification system 108 determines based on the similarity score 120 that the delivered item is significantly not as described by the item listing (block 1608 shown by FIG. 16). As a result, the service provider system 102 outputs the response 124 (block 1610 shown by FIG. 16) and performs operations associated with the resolution at block 520 such as notifying the recipient that the item return request is approved and/or notifying the supplier with instructions for receiving the item to be returned. Thus, the content of the response 124 output by the item condition verification system 108 is leveraged by the service provider system 102 to bypass manual review of the item return request. In particular, the manual review described above that occurs at block 518 in the example of the item return request that proceeds along the second route is not included when the item return request proceeds along the third route 506. The item condition verification system 108 thereby reduces or eliminates human intervention, such as manual review, for resolving the item return request.

In yet another implementation, the content of response 124 is based on outcome 526 in which the similarity score 120 is between the first threshold score and the second threshold score. In this situation, the item condition verification system 108 determines based on the similarity score 120 that additional review of the item return request is suggested. As a result, the service provider system 102 flags the item return request for manual review.

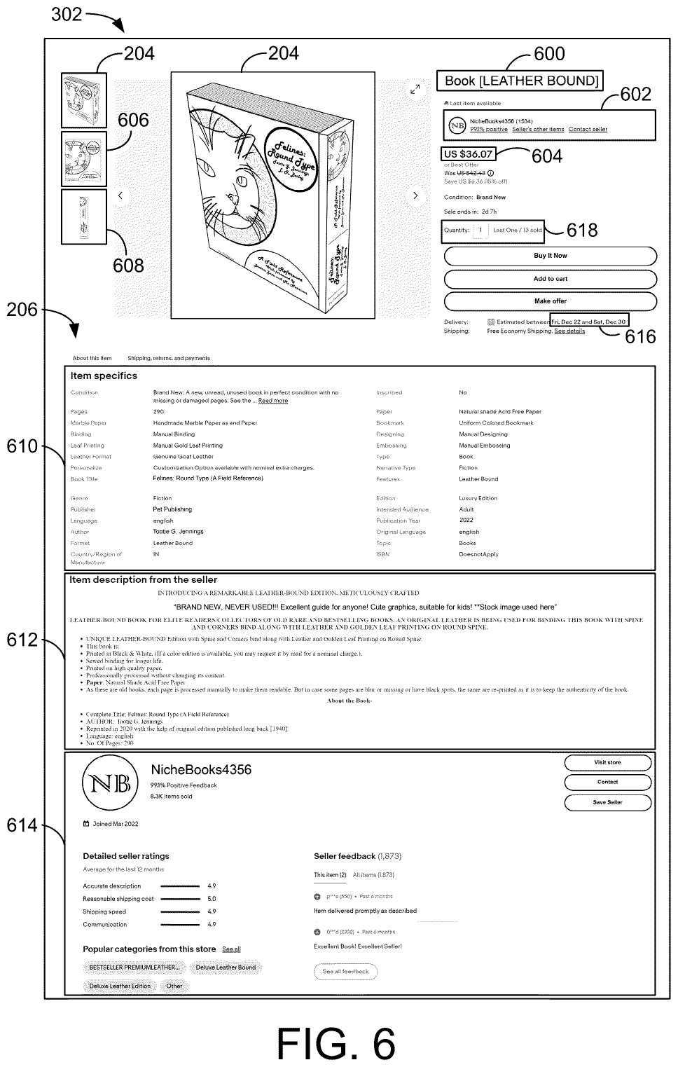

Referring to FIG. 6, an example depiction of item listing 302 is shown. The item listing 302 is shown as it would appear through an application of a computing device, such as a web browser of computing device 104 shown by FIG. 1. The item listing 302 includes a plurality of digital images describing the listed item, such as marketed digital image 204, a second marketed digital image 606, and a third marketed digital image 608. In the example shown, the listed item is a book. However, in other examples, the listed item is a different type of item such as an apparel item, a decorative houseware item, or other type of item. The item listing 302 is one of a plurality of item listings implemented by the e-commerce platform supported by the service provider system 102.

The item listing 302 includes additional information describing the marketed condition of the item. In the example shown, the item listing 302 includes title 600 and marketed textual description 206. The marketed textual description 206 includes item categorical data 610. The item categorical data 610 is formatted as a categorical list describing various features and attributes of the item, such as a used/new condition of the item, material of the item, manufacturer or publisher of the item, and so forth. The various categories of information included by the item categorical data 610 are defined by the e-commerce platform and are populated with information provided by listing entity. As the categories are defined by the e-commerce platform, the type of information included in the item categorical data 610 can be standardized across multiple item listings. For example, another item listing for a book, different than the item listing 302, includes a categorical data section with a categorical list similar to the list shown by item listing 302. However, the information populating the categorical list of each item listing can be different.

The marketed textual description 206 further includes item description 612. The item description 612 is formatted as a plain language description of the item, such as one or more paragraphs describing various features and attributes of the item. The item description 612 includes non-categorical information such as a description of authenticity of the item, an intended use of the item, a rarity of the item, and so forth.

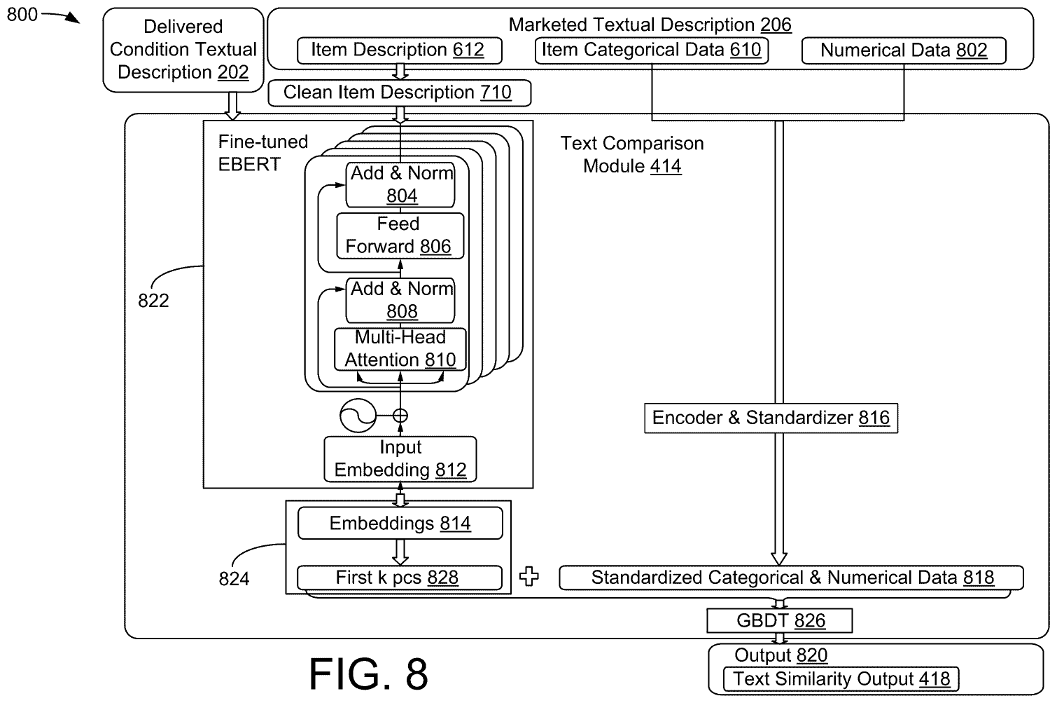

The item listing 302 additionally includes listing entity information 614 describing the listing entity, e.g., the supplier of the item. The listing entity information 614 includes information such as a profile name of the listing entity, a rating of the listing entity, recent transaction feedback for the listing entity, and so forth. A partial summary 602 of the information included in the listing entity information 614 is also shown by the item listing 302. The item listing 302 further includes various information classified as numerical data, such as item price 604, item delivery timeframe 616, item quantities 618, and so forth. In some implementations the numerical data is processed by the text comparison module 414, such as in the example described further below with reference to FIG. 8.

The item condition verification system 108 acquires the item listing 302 for the purpose of retrieving information from the item listing 302 (block 1602 shown by FIG. 16). The item condition verification system 108 further provides the retrieved information as input to the modules of the item condition verification system 108. For example, to perform item condition comparison operations via condition comparison module 110, the item condition verification system 108 acquires the item listing 302 and provides information from the item listing 302 to the condition comparison module 110. Acquiring the item listing 302 includes retrieving the item listing 302 from database 300 in some implementations.

The item condition verification system 108 further identifies a marketed condition for the item associated with the item listing based on a content of the item listing (block 1604 shown by FIG. 16). The item listing 302 includes various types of data such as the item description, item categorical data, digital images, and so forth. The data in the item listing represents the marketed condition of the item. The item condition verification system 108 acquires the different types of data from the item listing 302 and processes the data via various modules to perform the operations described herein.

The item listing 302 depicted is one example of an item listing supported by the service provider system 102. The service provider system 102 is implemented to support a plurality of different item listings. Although the item described by the item listing 302 is a book, other item listings may describe other types of items. The operations performed by the item condition verification system 108 using data from the item listing 302, such as operations including image comparison, textual comparison, and similarity score output, can also be performed for other item listings supported by the service provider system 102.

For example, consider a scenario in which a listing entity interacts with the service provider system 102 to provide information for generation of another item listing. In this scenario, the item described by the item listing is a shoe. Examples of information input by the listing entity can include a title for the item listing, one or more digital images of the shoe, a written description of the shoe, a history or record of the shoe, categorical data for the shoe such as brand, colorway, etc., numerical data for the shoe such as a date of manufacture of the shoe, among other information. The service provider system 102 generates the item listing based on the provided information. Following a delivery of the shoe to a recipient and responsive to initiation of a return request by the recipient, the service provider system 102 employs the item condition verification system 108 according to the techniques described herein. In particular, the item condition verification system 108 is employed to compare the information from the item listing to information describing the delivered condition of the item as provided by the recipient. The item condition verification system 108 then outputs a similarity score describing an amount of similarity between the delivered condition of the item and the condition of the item described by the item listing, e.g., the marketed condition. Based on the similarity score, the service provider system 102 performs operations such as notifying the recipient that the item return request is approved and/or notifying the supplier with instructions for receiving the item to be returned.

Referring to FIG. 7, a first block diagram 700 and a second block diagram 702 are shown each depicting operations employing an output of the text extraction module 426 of FIG. 4. In the implementation depicted by FIG. 7, the text extraction module 426 processes the marketed textual description 206 including the item description 612. The text extraction module 426 outputs text extracted from the item description 612 that is processed via cleanup model 708. The cleanup model 708 outputs a clean item description 710 that is input to the text comparison module 414. The clean item description 710 includes keywords and other descriptive information from the item description 612. Although not shown, the text extraction module 426 is operable to process the delivered condition textual description 202 in a similar way to generate a second clean item description. The second clean item description includes information from the delivered condition textual description 202. The second clean item description is also received as input by the text comparison module 414. The text comparison module 414 then performs the text comparison operations described herein. Such operations include comparing the two clean item descriptions to generate the text similarity output 418 shown by FIG. 4.

As shown by the first block diagram 700, marketed textual description 206 is input to the text extraction module 426. The text extraction module 426 processes the marketed textual description 206 via extraction model 704 to generate extracted text 706. In some implementations, the extracted text 706 is further processed as depicted by the second block diagram 702 and is then provided to the cleanup model 708. The cleanup model 708 generates clean item description 710. In some implementations, the cleanup model 708 identifies keywords included by the extracted text 706 and generates clean item description 710 based on the keywords. Such keywords include, for instance, words describing physical attributes or other aspects of the listed item. The cleanup model 708 omits words and phrases describing elements that are unrelated to the attributes of the listed item during generation of the clean item description 710. Such unrelated elements include shipping information, payment information, and contact information, for instance. The cleanup model 708 is a large language model (LLM) in some implementations.

The second block diagram 702 shows operations depicted by the first block diagram 700 in greater detail. The extracted text 706 is processed using a generative AI few shots prompting model at block 712 to generate processed extracted text 714. The processed extracted text 714 and the marketed textual description 206 are each input to the cleanup model 708. In the implementation shown, the cleanup model 708 is a fine-tuned bidirectional and auto-regressive transformers (BART) model. The cleanup model 708 uses bidirectional encoder 716 and autoregressive decoder 718 for generating clean item description 710 from the marketed textual description 206 and the processed extracted text 714. The clean item description 710 output by the cleanup model 708 is input to the text comparison module 414. The text comparison module 414 is implemented to perform text comparison operations as described above.

In an example implementation, the text extraction module 426 uses extraction model 704 to extract the item description 612 from the marketed textual description 206 as extracted text 706. Extraction model 704 is a machine learning model such as a large language model, in some implementations. In this example, the extracted text 706 includes information describing attributes of the item. Such attributes may include, but are not limited to, dimensions of the item, a name of the item, a brand of the item, a wear condition of the item, an age of the item, and a colorway of the item. The extracted text 706 also includes information that does not directly describe attributes of the item. Such information includes, for example, a description of other items, a description of a location of the listing entity, a description of desired recipients, and a description of listing entity policies.

The extracted text 706 is processed via generative AI few shots prompting at block 712, which results in generation of the processed extracted text 714. In this example, the processed extracted text 714 includes the information describing the attributes of the item. However, the processed extracted text 714 does not include the information that does not directly describe the attributes of the item. Accordingly, the processed extracted text 714 is more easily and accurately processed by the cleanup model 708 as compared to providing the extracted text 706 directly to the cleanup model 708 without processing the extracted text 706 via the generative AI few shots prompting at block 712.

Referring to FIG. 8, a block diagram 800 is shown depicting operations performed by text comparison module 414. The text comparison module 414 receives clean item description 710, item categorical data 610, and numerical data 802 associated with the marketed textual description 206 as input. The clean item description 710 is generated from the item description 612 as described above with reference to FIG. 7. The text comparison module 414 further receives delivered condition textual description 202 as input.

The item categorical data 610 and numerical data 802 are processed by encoder and standardizer 816 of the text comparison module 414. The encoder and standardizer 816 outputs standardized categorical and numerical data 818.

The clean item description 710 and the delivered condition textual description 202 are processed by machine learning model 822. In the implementation shown, the machine learning model 822 is a Fine-Tuned Efficient Bidirectional Encoder Representations from Transformers (EBERT) model.

The machine learning model 822 receives the clean item description 710 and the delivered condition textual description 202 and processes the received information in accordance with the operations indicated by add and norm block 804, feed forward block 806, add and norm block 808, and multi-head attention block 810. The machine learning model 822 further generates input embeddings 812.

An output of the machine learning model 822 is further processed at principal component analysis (PCA) block 824 which utilizes embeddings 814 and first k principal components (PCs) 828 to generate an output to be input to gradient-boosted decision tree (GBDT) 826. The standardized categorical and numerical data 818 is additionally input to the GBDT 826, and the GBDT 826 generates output 820.

In an example implementation, the clean item description 710 includes information from the item listing 302 that describes attributes of the listed item. The attributes of the listed item are similar to the example attributes described above. The clean item description 710 omits information that does not describe the listed item, such as a description of other items or a description of a location of the listing entity. With regard to the example of the book depicted by the item listing 302, for instance, the clean item description 710 includes information describing attributes of the book such as the paper type, binding, and subject matter, to name a few. The categorical data includes data describing the book from the item categorical data 610 of the item listing 302. Such categorical data includes, for instance, the publisher of the book, the genre of the book, the language of the book, and the author of the book, to name a few. The numerical data includes data describing the book such as the price of the book from the item listing 302, the publication year of the book, the number of pages of the book, and the amount of copies of the book that are available, among other information. In some implementations, the numerical data is at least partially extracted from the categorical data.

The text comparison module 414 processes the various data to generate the output 820 including the text similarity output 418. In this example, the text similarity output 418 describes the amount of similarity between the delivered condition of the book and the marketed condition of the book. In particular, the text similarity output 418 indicates the amount of similarity between the delivered condition textual description 202 and the textual information included by the marketed textual description 206, e.g., the item description 612, the item categorical data 610, and the numerical data 802. The output 820 includes additional information in some implementations. Such additional information includes, in some instances, a first indication of the amount of similarity between the delivered condition textual description 202 and the item description 612, an indication of the amount of similarity between the delivered condition textual description 202 and the item categorical data 610, and an indication of the amount of similarity between the delivered condition textual description 202 and the numerical data 802.

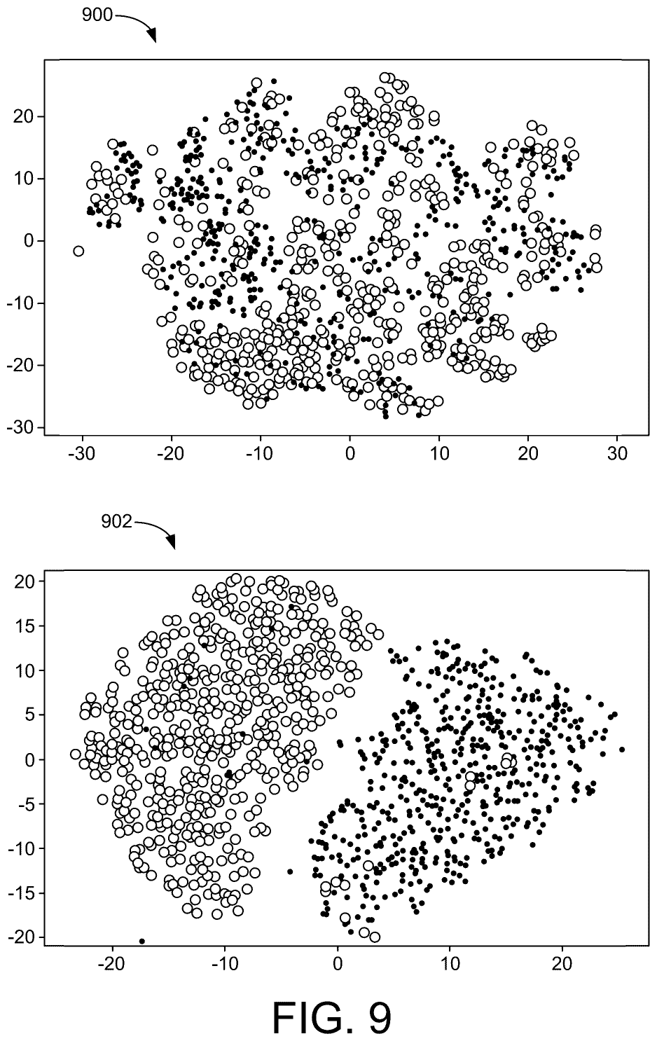

Referring to FIG. 9, two graphs are shown depicting embeddings of the machine learning model 822 of FIG. 8 under different conditions. In particular, a first graph 900 is shown depicting embeddings of the machine learning model 822 without fine-tuning, and second graph 902 depicts embeddings of the machine learning model 822 with fine-tuning. The embeddings are represented in each graph by individual dots. In the graphs, the larger outlined dots shown without a dark fill represent embeddings associated with outcomes that indicate that an item is significantly not as described by a corresponding item listing. The smaller dots with the dark fill represent embeddings associated with outcomes that indicate that an item is sufficiently described by a corresponding item listing, e.g., not misrepresented by the item listing. As shown by the first graph 900, without fine-tuning, the embeddings are not substantially separated and mixing of the embeddings within areas of the first graph 900 is relatively high. However, with fine-tuning applied as represented by the second graph 902, the embeddings are substantially separated and demonstrate much less mixing as compared to the configuration without fine-tuning.

The embeddings represented by the first graph 900 and the second graph 902 are based on data describing a plurality of transactions and outcomes, in some implementations. For example, each respective dot represents embeddings associated with item verification operations performed by the item condition verification system 108 for a single item return request associated with a single respective item listing. In a scenario involving the item listing 302 depicting the book described above, an item return request for the book is initiated. In response to the item return request, the item condition verification system 108 is employed to acquire textual information describing the marketed condition of the book, such as the item description 612, item categorical data 610, and numerical data 802. The item condition verification system 108 further acquires textual information describing the delivered condition of the book, e.g., delivered condition textual description 202. The item condition verification system 108 processes the acquired textual information as described above with reference to FIGS. 7-8. To do so, the acquired information is processed via machine learning model 822. In this scenario, the embeddings of the machine learning model 822 associated with the processing of the textual information describing the book are represented by a single dot in the second graph 902. Each other dot represents embeddings associated with processing of textual information for a different respective item return request involving a different item listing.

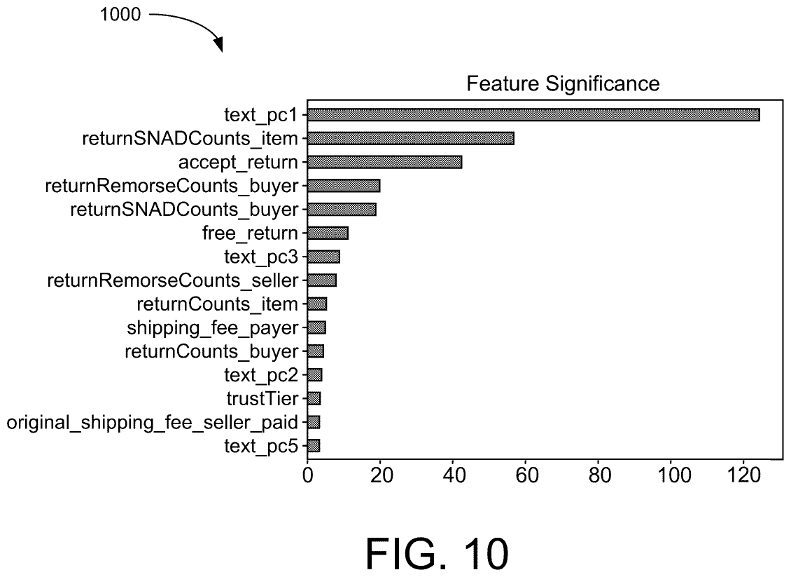

Referring to FIG. 10, a graph 1000 depicting a relative feature significance for various types of textual information provided to the text comparison module 414 is shown. The feature significance indicates a significance of each type of textual information toward determining whether an item is significantly not as described by an item listing. The horizontal axis of the graph 1000 represents the significance of each particular type of text content, with the types of text content indicated along the vertical axis. In the depicted graph 1000, at least some of the indicated text content is included by marketed textual description 206. Similar significances apply to text content included by delivered condition textual description 202, at least in some implementations.

In the graph 1000, “text_pc1” refers to a principal component output by machine learning model 822 as described above. The principal component is based on text included by clean item description 710, in some implementations, and thus represents a type of text content included by the clean item description 710. The principal component has higher significance than other types of text content used to perform the determination, such as “returnSNADCounts_item” indicating a number of item returns performed for similar items included in other item listings. In the scenario described above involving the item listing 302 depicting the book, the feature significance depicted by the graph 1000 indicates the relative significance of information describing the book used to determine whether the delivered condition of the book is significantly not as described by the item listing 302. In this scenario, “text_pc1” is based on the clean item description 710 generated from the item description 612 acquired from the item listing 302. Graph 1000 therefore indicates that the description of the book included by the item description 612 has a high significance in determining whether the delivered book is significantly not as described by the item listing 302.

Referring to FIG. 11, an implementation of category similarity module 402 of the image comparison module 400 of condition comparison module 110 is shown. In this implementation, marketed digital image 204 is acquired from item listing 302 and delivered condition digital image 200 is acquired from computing device 104.

The marketed digital image 204 and the delivered condition digital image 200 are input to the category similarity module 402. The category similarity module 402 compares the delivered condition digital image 200 and the marketed digital image 204. Following the comparison, the category similarity module 402 outputs a category similarity result 1100. The category similarity result 1100 indicates an amount of categorical similarity between the delivered condition digital image 200 and the marketed digital image 204. Categorical similarity includes, for instance, color similarity of the images and/or histogram similarity of the images. In some implementations, the category similarity module 402 generates the category similarity result 1100 through the use of vector embedding. The vector embedding encodes aspects of each image as vector data, and the vector data of the images is compared to determine the amount of similarity between the images.

In the example of the item listing 302 depicting the book, the category similarity result 1100 includes, for instance, the amount of similarity between the histogram of digital images describing the delivered condition of the book, e.g., the delivered condition digital image 200, and the histogram of digital images describing the marketed condition of the book, e.g., the marketed digital image 204. The category similarity result 1100 additionally or alternatively includes, in some instances, the similarity between the colors included by the digital images describing the delivered condition of the book (e.g., pixel hue, saturation, and brightness) and the colors included by the digital images describing the marketed condition of the book.

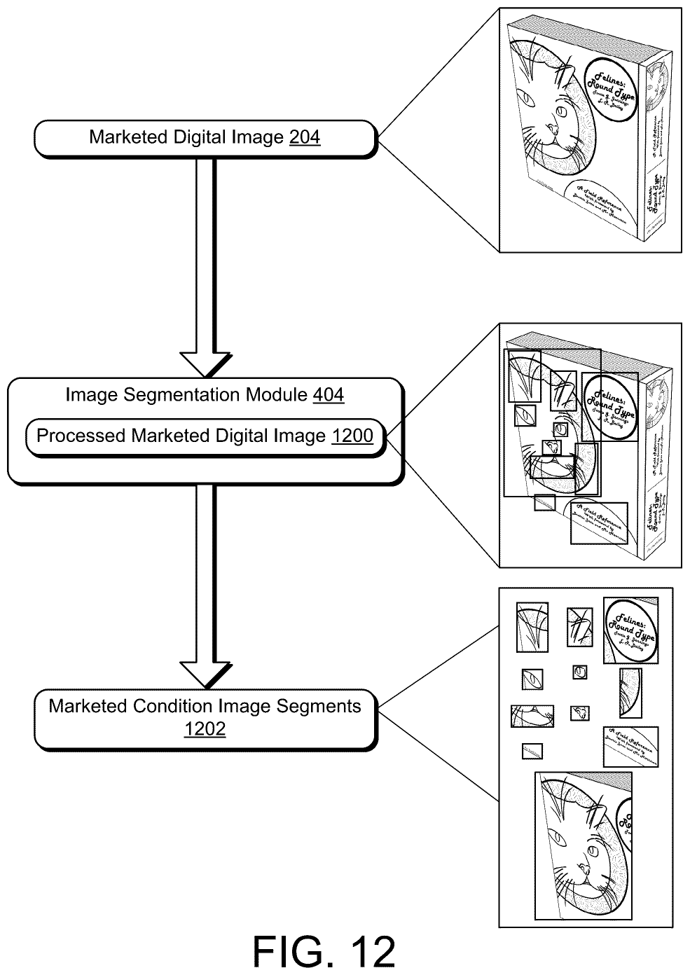

Referring to FIG. 12, an implementation of image segmentation module 404 of the image comparison module 400 of condition comparison module 110 is shown. The image segmentation module 404 receives the marketed digital image 204 and processes the marketed digital image 204. Processing the marketed digital image 204 via image segmentation module 404 results in generation of processed marketed digital image 1200. The processed marketed digital image 1200 includes a plurality of image segments. Each image segment includes one or more features of the image that identify the content of the image. For example, the image segmentation module 404 is operable to detect edges, patterns, or other features in the marketed digital image 204. Based on the detected edges and other features, the image segmentation module 404 generates the processed marketed digital image 1200 with the various image segments indicating the detected features. The image segmentation module 404 then outputs marketed condition image segments 1202 based on the segments identified in processed marketed digital image 1200.

In some implementations, the image segmentation module 404 processes the marketed digital image 204 and generates the marketed condition image segments 1202 using one or more machine learning models. The one or more machine learning models include, in some instances, a multi-modal machine learning model implementing an image encoder, a prompt encoder, and a mask decoder. In some instances, the one or more machine learning models additionally or alternatively include a convolutional neural network (CNN) and a generative adversarial network (GAN).

In the example described above in which the item listing 302 depicts the book, the marketed condition image segments 1202 depict individual features of the book visible in the marketed digital image 204 such as the title, cover symbols, cover illustrations, publisher name, patterning, and author.

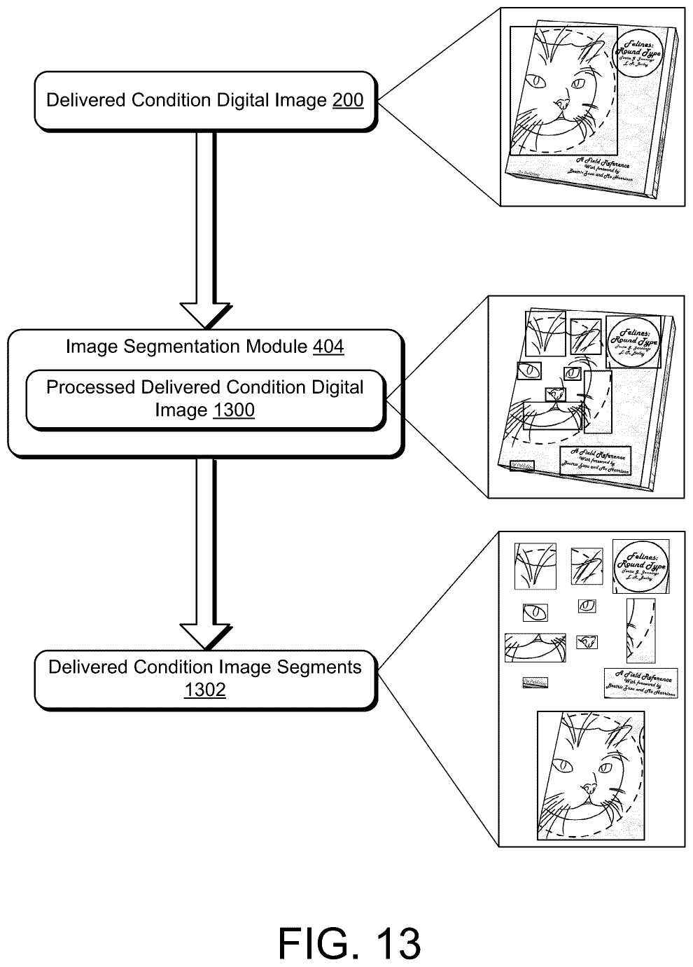

Referring to FIG. 13, another implementation of image segmentation module 404 of the image comparison module 400 is shown. The implementation shown by FIG. 13 is similar to the implementation shown by FIG. 12 and described above. In particular, the image segmentation module 404 receives delivered condition digital image 200 and processes the delivered condition digital image 200 to generate processed delivered condition digital image 1300. The processed delivered condition digital image 1300 includes a plurality of image segments. Each image segment includes one or more features of the image that identify the content of the image. The image segmentation module 404 outputs delivered condition image segments 1302 based on the processed delivered condition digital image 1300, e.g., using the machine learning model described above with reference to FIG. 12.

In the example described above in which the item listing 302 depicts the book, the delivered condition image segments 1302 depict individual features of the book visible in the delivered condition digital image 200 such as the title, cover symbols, cover illustrations, publisher name, patterning, and author.

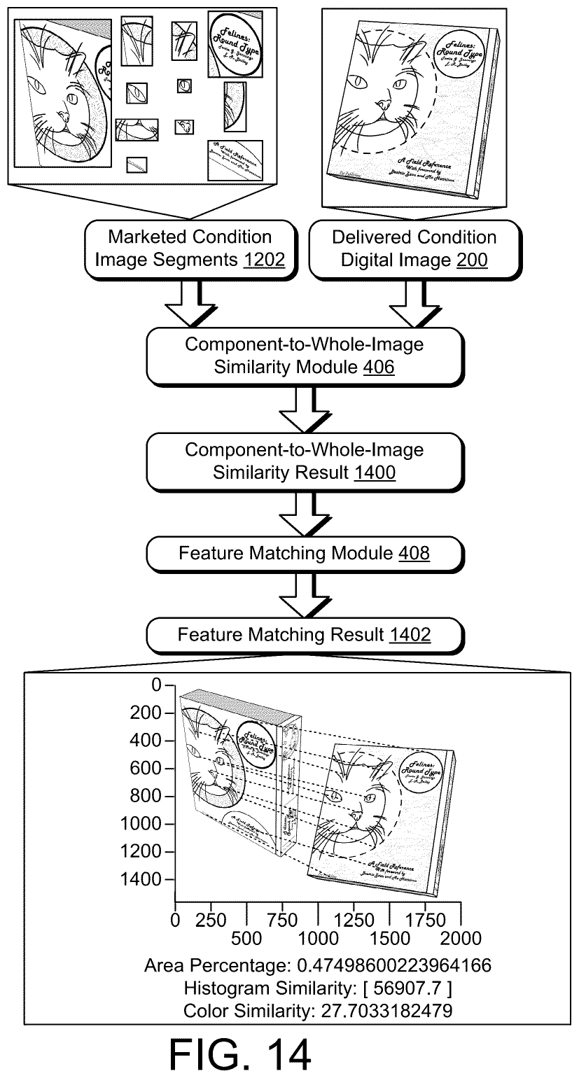

Referring to FIG. 14, an implementation of component-to-whole-image similarity module 406 and feature matching module 408 of the image comparison module 400 is shown. The component-to-whole-image similarity module 406 receives the marketed condition image segments 1202 and the delivered condition digital image 200. The component-to-whole-image similarity module 406 compares the marketed condition image segments 1202 with the delivered condition digital image 200 and outputs component-to-whole-image similarity result 1400. The component-to-whole-image similarity result 1400 includes, in some implementations, a data set indicating an amount of similarity of each of the marketed condition image segments 1202 to the delivered condition digital image 200.

The feature matching module 408 receives the component-to-whole-image similarity result 1400 and processes the component-to-whole-image similarity result 1400 to generate feature matching result 1402. The feature matching result 1402 includes an indication of an amount of similarity of the delivered condition digital image 200 to the marketed digital image 204.

In the example described above in which the item listing 302 depicts the book, the component-to-whole-image similarity module 406 compares each image segment of the marketed condition image segments 1202 to the delivered condition digital image 200. The amount of similarity of each image segment to the delivered condition digital image 200 is leveraged to map each image segment to a corresponding portion of the delivered condition digital image 200 via feature matching module 408. For example, the feature matching module 408 generates a set of coordinates associated with each image segment, where each set of coordinates indicates a corresponding portion of the delivered condition digital image 200. Thus, each image segment is matched to a corresponding portion of the delivered condition digital image 200.

The feature matching module 408 generates feature matching result 1402 based on the amount of the delivered condition digital image 200 that matches the marketed condition image segments 1202. In some implementations, the feature matching result 1402 includes an area percentage indicating the amount of area of the delivered condition digital image 200 that matches the marketed condition image segments 1202. In some implementations, the feature matching result 1402 additionally and/or alternatively includes a histogram similarity score and/or a color similarity score indicating the similarity of the marketed condition image segments 1202 to the delivered condition digital image 200.

Although not depicted, in some implementations the component-to-whole-image similarity module 406 additionally or alternatively compares the delivered condition image segments 1302 to the marketed digital image 204 to determine the amount of similarity between the delivered condition image segments 1302 and the marketed digital image 204.

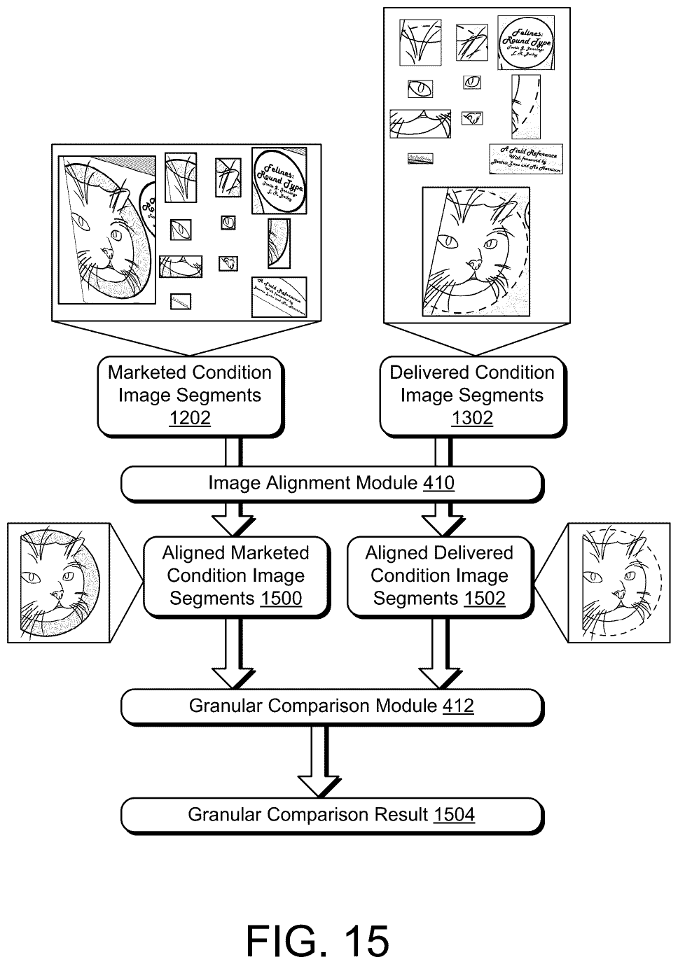

Referring to FIG. 15, an implementation of the image alignment module 410 and the granular comparison module 412 of the image comparison module 400 is shown. The image alignment module 410 receives the marketed condition image segments 1202 and processes the marketed condition image segments 1202 to generate aligned marketed condition image segments 1500. Further, the image alignment module 410 receives the delivered condition image segments 1302 and processes the delivered condition image segments 1302 to generate aligned delivered condition image segments 1502.

The aligned marketed condition image segments 1500 include the marketed condition image segments 1202 that have been transformed by the image alignment module 410. The transforming of the marketed condition image segments 1202 includes adjusting an aspect ratio of the marketed condition image segments 1202, adjusting an orientation and/or skewing of the marketed condition image segments 1202, and so forth. The marketed condition image segments 1202 are transformed to reduce an appearance of foreshortening, tilting, rotation, and other effects that alter the appearance of portions of the marketed digital image 204 compared to an appearance of the portions without such effects. For example, marketed condition image segments 1202 that have a rotated appearance are transformed by the image alignment module 410 to generate aligned marketed condition image segments 1500 having a non-rotated appearance. The delivered condition image segments 1302 are adjusted in a similar way by image alignment module 410 generate the aligned delivered condition image segments 1502.

The aligned marketed condition image segments 1500 and the aligned delivered condition image segments 1502 are provided to the granular comparison module 412. The granular comparison module 412 processes the input images and generates granular comparison result 1504. The processing of the images by granular comparison module 412 includes, for instance, comparing a granularity of the aligned marketed condition image segments 1500 to a granularity of the aligned delivered condition image segments 1502 via a scale-invariant feature transform (SIFT) algorithm and outputting a score based on the compared granularity.

### Example System and Device

Referring to FIG. 17, an example system 1700 is depicted that includes an example computing device 1702 that is representative of one or more computing systems and/or devices that are usable to implement the various techniques described herein. This is illustrated through inclusion of the service provider system 102 including item condition verification system 108. Computing device 1702 includes, for example, a server of service provider system 102, a device associated with a client (e.g., a client device), an on-chip system, and/or any other suitable computing device or computing system. The computing device 1702 is referred to herein as a processing device in some instances.

The example computing device 1702 as illustrated includes a processing system 1704, one or more computer-readable media 1706, and one or more input/output interfaces 1708 that are communicatively coupled, one to another. Although not shown, the computing device 1702 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1704 is representative of functionality to perform one or more operations using hardware. Accordingly, the processing system 1704 is illustrated as including hardware elements 1710 that are configured as processors, functional blocks, and so forth. This includes example implementations in hardware as a system specific integrated circuit or other logic device formed using one or more semiconductors. The hardware elements 1710 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1706 is illustrated as including memory/storage 1712. The memory/storage 1712 represents memory/storage capacity associated with one or more computer-readable media. In one example, the memory/storage 1712 includes volatile media (such as random access memory (RAM)) and/or nonvolatile media (such as read only memory (ROM), Flash memory, optical disks, magnetic disks, and so forth). In another example, the memory/storage 1712 includes fixed media (e.g., RAM, ROM, a fixed hard drive, and so on) as well as removable media (e.g., Flash memory, a removable hard drive, an optical disc, and so forth). The computer-readable media 1706 is configurable in a variety of other ways as further described below.

Input/output interfaces 1708 are representative of functionality to allow user input to enter commands and information to computing device 1702, and also allow information to be presented and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1702 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 1702. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The one-or-more computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 1702, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1710 and computer-readable media 1706 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, a system-specific integrated circuit (ASIC), a field-programmable gate array (FPGA), a complex programmable logic device (CPLD), and other implementations in silicon or other hardware. In this context, hardware operates as a computing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 1710. For example, the computing device 1702 is configured to implement particular instructions and/or functions corresponding to the software and/or hardware modules. Accordingly, implementation of a module that is executable by the computing device 1702 as software is achieved at least partially in hardware, e.g., through use of computer-readable storage media and/or hardware elements 1710 of the processing system 1704. The instructions and/or functions are executable/operable by one or more articles of manufacture (for example, one or more computing devices such as computing device 1702 and/or processing systems such as processing system 1704) to implement techniques, modules, and examples described herein.

The techniques described herein are supportable by various configurations of the computing device 1702 and are not limited to the specific examples of the techniques described herein. This functionality is also implementable entirely or partially through use of a distributed system, such as over a “cloud” 1714 as described below.

The cloud 1714 includes and/or is representative of a platform 1716 for resources 1718. The platform 1716 abstracts underlying functionality of hardware (e.g., servers) and software resources of the cloud 1714. For example, the resources 1718 include systems and/or data that are utilized while computer processing is executed on servers that are remote from the computing device 1702. In some examples, the resources 1718 also include services provided over the Internet and/or through a subscriber network, such as a cellular or Wi-Fi network.

The platform 1716 abstracts the resources 1718 and functions to connect the computing device 1702 with other computing devices. In some examples, the platform 1716 also serves to abstract scaling of resources to provide a corresponding level of scale to encountered demand for the resources that are implemented via the platform. Accordingly, in an interconnected device embodiment, implementation of functionality described herein is distributable throughout the system 1700. For example, the functionality is implementable in part on the computing device 1702 as well as via the platform 1716 that abstracts the functionality of the cloud 1714.

### CONCLUSION

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter. Further, various different examples are described and it is to be appreciated that each described example is implementable independently or in connection with one or more other described examples.

What is claimed is:

1. A method for item condition verification implemented by a computing device, comprising:
receiving, by the computing device, an item listing of an item;
identifying, by the computing device, a marketed condition for the item based on the item listing;
comparing, by the computing device, the marketed condition with data describing a delivered condition of the item, the comparing performed using one or more machine learning models;
determining, by the computing device, whether the item is significantly not as described by the item listing based on the comparing; and
outputting, by the computing device, a result of the determining.

2. The method as described in claim 1, wherein the comparing includes determining, via the one or more machine learning models, similarity between:
a textual description from the item listing; and
a textual description from the data describing the delivered condition of the item.

3. The method as described in claim 1, wherein the comparing includes determining, via the one or more machine learning models, similarity between:
a digital image from the item listing; and
a digital image from the data describing the delivered condition of the item.

4. The method as described in claim 3, wherein determining similarity between the digital image from the item listing and the digital image from the data describing the delivered condition of the item includes:
generating a plurality of image segments from the digital image from the item listing; and
comparing the plurality of image segments to the digital image from the data describing the delivered condition of the item via the one or more machine learning models.

5. The method as described in claim 4, wherein generating the plurality of image segments from the digital image from the item listing is performed using a convolutional neural network or a generative adversarial network of the one or more machine learning models.

6. The method as described in claim 1, wherein the comparing includes determining, via the one or more machine learning models, similarity between:
a digital image from the item listing; and
a textual description from the data describing the delivered condition of the item.

7. The method as described in claim 1, wherein the comparing includes determining, via the one or more machine learning models, similarity between:
a textual description from the item listing; and
a digital image from the data describing the delivered condition of the item.

8. The method as described in claim 1, wherein the one or more machine learning models are trained using training data describing a plurality of item transactions and outcomes.

9. The method as described in claim 1, wherein comparing the marketed condition with data describing the delivered condition of the item using the one or more machine learning models includes generating a similarity score describing an amount of similarity between the marketed condition and the delivered condition.

10. The method as described in claim 9, wherein determining whether the item is significantly not as described by the item listing includes comparing the similarity score to a threshold similarity score.

11. The method as described in claim 10, further comprising weighting the similarity score or the threshold similarity score based on a listing entity transaction history.

12. The method as described in claim 10, wherein a content of the result is based on a difference between the similarity score and the threshold similarity score.

13. The method as described in claim 12, wherein the content of the result includes an indication that the item is significantly not as described by the item listing while the similarity score is less than the threshold similarity score.

14. A system, comprising:
one or more computing devices; and
one or more computer-readable storage media storing instructions which, when executed by the one or more computing devices, cause the one or more computing devices to perform operations comprising:
receiving an item listing of an item;
identifying a marketed condition for the item based on the item listing;
comparing the marketed condition with data describing a delivered condition of the item, the comparing performed using one or more machine learning models;
determining whether the item is significantly not as described by the item listing based on the comparing; and
outputting a result of the determining.

15. The system as described in claim 14, wherein the instructions further comprise:
generating a similarity score describing an amount of similarity between the marketed condition and the delivered condition.

16. The system as described in claim 15, wherein the instructions further comprise:
comparing the similarity score to a threshold similarity score; and
controlling the result of the determining based on a difference between the similarity score and the threshold similarity score.

17. The system as described in claim 14, wherein the instructions further comprise:
while comparing the marketed condition with data describing the delivered condition of the item, determining similarity between:
a digital image or a textual description from the item listing; and
a digital image or a textual description from the data describing the delivered condition of the item.

18. A computer-readable storage medium storing executable instructions that, responsive to execution by one or more processing devices, causes the one or more processing devices to perform operations including:
receiving an item listing of an item;
identifying a marketed condition for the item based on the item listing;
comparing the marketed condition with data describing a delivered condition of the item, the comparing performed using one or more machine learning models;
determining whether the item is significantly not as described by the item listing based on the comparing; and
outputting a result of the determining.

19. The computer-readable storage medium of claim 18, the operations further comprising:
generating a similarity score describing an amount of similarity between the marketed condition and the delivered condition;
determining a difference between the similarity score and a threshold similarity score; and
controlling the result of the determining based on the difference.

20. The computer-readable storage medium of claim 18, the operations further comprising:
acquiring a textual description from the item listing;
extracting text from the textual description;
generating a clean item description from the extracted text; and
inputting the clean item description to the one or more machine learning models to determine an amount of similarity between the textual description from the item listing and a textual description from the data describing the delivered condition of the item.
